(19) United States
(12) Patent Application Publication
(10) Pub. No.: US 2024/0151152 A1
(43) Pub. Date: May 9, 2024

(54) SEAL FOR GAS TURBINE ENGINE

(71) Applicant: Raytheon Technologies Corporation, Farmington, CT (US)

(72) Inventors: Fadi S. Maalouf, East Hampton, CT (US); Theodore W. Kapustka, Glastonbury, CT (US)

(21) Appl. No.: 18/053,483

(22) Filed: Nov. 8, 2022

(51) Int. Cl. F01D 11/00; F01D 11/18

(52) U.S. Cl. CPC F01D 11/001; F01D 11/18; F05D 2240/57

(57) ABSTRACT

A seal assembly for a gas turbine engine includes a seal carrier located at a first rotating component of the gas turbine engine. The seal carrier includes an axially forward seal carrier and an axially aft seal carrier. The axially aft seal carrier is located aft of the axially forward seal carrier relative to an engine central longitudinal axis. The axially forward seal carrier and the axially aft seal carrier define a seal recess therebetween. A seal body is positioned in the seal recess and is configured to slidably move in the seal recess and seal to a second rotating component of the gas turbine engine.

### BACKGROUND

Exemplary embodiments of the present disclosure pertain to the art of gas turbine engines. In particular, the present disclosure relates to seal arrangements for gas turbine engines.

Within gas turbine engines, for example, within the high pressure compressor sections of a modern gas turbine engine it is necessary to keep air cavities, such as those between adjacent rotor stages, isolated for best system operating efficiency. That need for separation or isolation creates a need for a seal between the two cavities to prevent air leakage between the cavities. In the case where there is relative motion between the components where the seal is located, the use of a typical seal causes wear and binding in critical parts and leakage which may cause other problems during operation. In many instances, the relative motion is between a shaft and a disk rotating together at high speed, and the motion which causes the damaging wear is radial motion and axial motion.

### BRIEF DESCRIPTION

In one embodiment, a seal assembly for a gas turbine engine includes a seal carrier located at a first rotating component of the gas turbine engine. The seal carrier includes an axially forward seal carrier and an axially aft seal carrier. The axially aft seal carrier is located aft of the axially forward seal carrier relative to an engine central longitudinal axis. The axially forward seal carrier and the axially aft seal carrier define a seal recess therebetween. A seal body is positioned in the seal recess and is configured to slidably move in the seal recess and seal to a second rotating component of the gas turbine engine.

Additionally or alternatively, in this or other embodiments an axial width of the seal recess is greater than an axial width of the seal body.

Additionally or alternatively, in this or other embodiments the axially forward seal carrier includes a forward axial leg and a forward radial leg. The axially aft seal carrier includes an aft axial leg and an aft radial leg. One of the aft radial leg or the forward radial leg at least partially axially overlaps the other of the forward radial leg or the aft radial leg.

Additionally or alternatively, in this or other embodiments a thermal growth and mechanical growth of the seal carrier matches a thermal growth and mechanical growth of the first rotating component during operation of the gas turbine engine.

Additionally or alternatively, in this or other embodiments at least one of the axially forward seal carrier and the axially aft seal carrier includes a plurality of carrier slots to tune the thermal growth and mechanical growth performance of the seal carrier.

Additionally or alternatively, in this or other embodiments a thermal growth and a mechanical growth of the seal body matches a thermal growth and a mechanical growth of the second rotating component during operation of the gas turbine engine.

Additionally or alternatively, in this or other embodiments an inner radial surface of the seal body includes one or more undulations in the radial direction relative to the engine central longitudinal axis.

Additionally or alternatively, in this or other embodiments one or more of the axially forward seal carrier, the axially aft seal carrier and the seal body are full unitary rings extending around the engine central longitudinal axis.

In another embodiment, a gas turbine engine includes a shaft located at an engine central longitudinal axis. The shaft is configured to rotate about the engine central longitudinal axis. A rotor is located radially outboard of the shaft and extends about the engine central longitudinal axis. A seal assembly includes a seal carrier located at the rotor. The seal carrier includes an axially forward seal carrier and an axially aft seal carrier. The axially aft seal carrier is positioned aft of the axially forward seal carrier relative to the engine central longitudinal axis. The axially forward seal carrier and the axially aft seal carrier defines a seal recess therebetween. A seal body is positioned in the seal recess the seal body and is configured to slidably move in the seal recess and seal to the shaft.

Additionally or alternatively, in this or other embodiments an axial width of the seal recess is greater than an axial width of the seal body.

Additionally or alternatively, in this or other embodiments the axially forward seal carrier includes a forward axial leg and a forward radial leg. The axially aft seal carrier includes an aft axial leg and an aft radial leg. The aft radial leg at least partially axially overlaps the forward radial leg.

Additionally or alternatively, in this or other embodiments a thermal growth and a mechanical growth of the seal carrier matches a thermal growth and a mechanical growth of the rotor during operation of the gas turbine engine.

Additionally or alternatively, in this or other embodiments at least one of the axially forward seal carrier and the axially aft seal carrier includes a plurality of carrier slots to tune the thermal growth and mechanical growth performance of the seal carrier.

Additionally or alternatively, in this or other embodiments a thermal growth and a mechanical growth of the seal body matches a thermal growth and a mechanical growth of the shaft during operation of the gas turbine engine.

Additionally or alternatively, in this or other embodiments an inner radial surface of the seal body includes one or more undulations in the radial direction relative to the engine central longitudinal axis.

Additionally or alternatively, in this or other embodiments one or more of the axially forward seal carrier, the axially aft seal carrier and the seal body are full unitary rings extending around the engine central longitudinal axis.

In yet another embodiment, a method of assembling a seal assembly of a gas turbine engine includes installing an axially forward seal carrier to a rotor of the gas turbine engine and installing a seal body onto the axially forward seal carrier. An axially aft seal carrier is installed to the axially forward seal carrier such that the seal body is located in a seal recess defined between the axially forward seal carrier and the axially aft seal carrier.

Additionally or alternatively, in this or other embodiments a snap ring is installed to the rotor to secure the seal assembly to the rotor.

Additionally or alternatively, in this or other embodiments the axially aft seal carrier is installed to the axially forward seal carrier via an interference fit.

Additionally or alternatively, in this or other embodiments an axial width of the seal recess is greater than an axial width of the seal body in the seal recess.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a partial cross-sectional view of an embodiment of an interface between a rotating shaft and a rotor of a gas turbine engine;

FIG. 3 is a partial cross-sectional view of an embodiment of a seal assembly of a gas turbine engine;

FIG. 4 is a schematic illustration of an embodiment of a seal body of a seal assembly.

### DETAILED DESCRIPTION

A detailed description of one or more embodiments of the disclosed apparatus and method are presented herein by way of exemplification and not limitation with reference to the Figures.

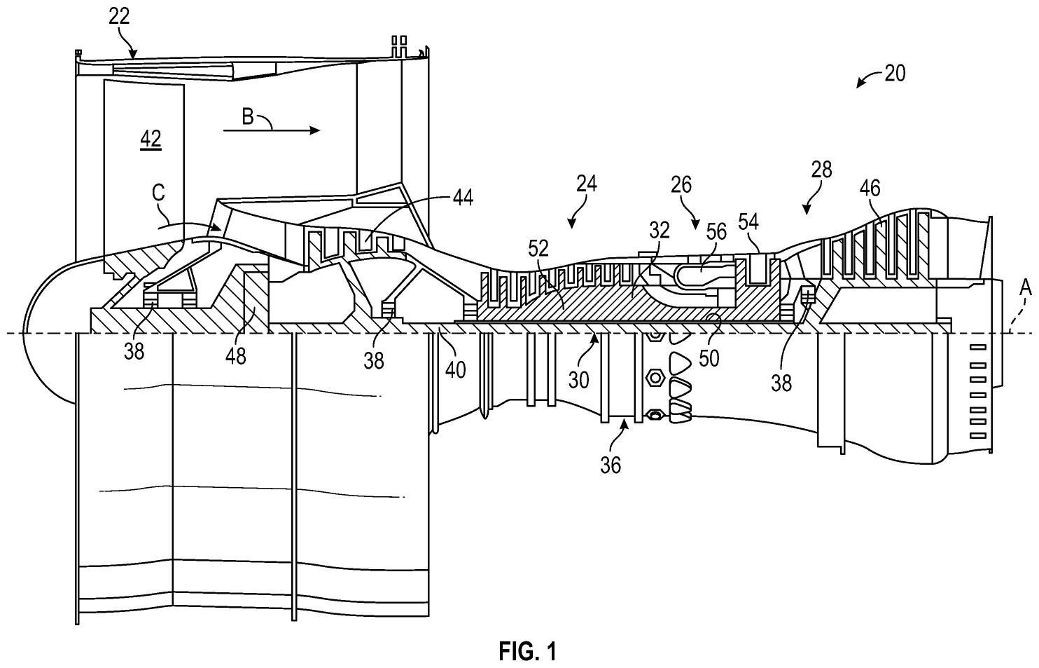

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

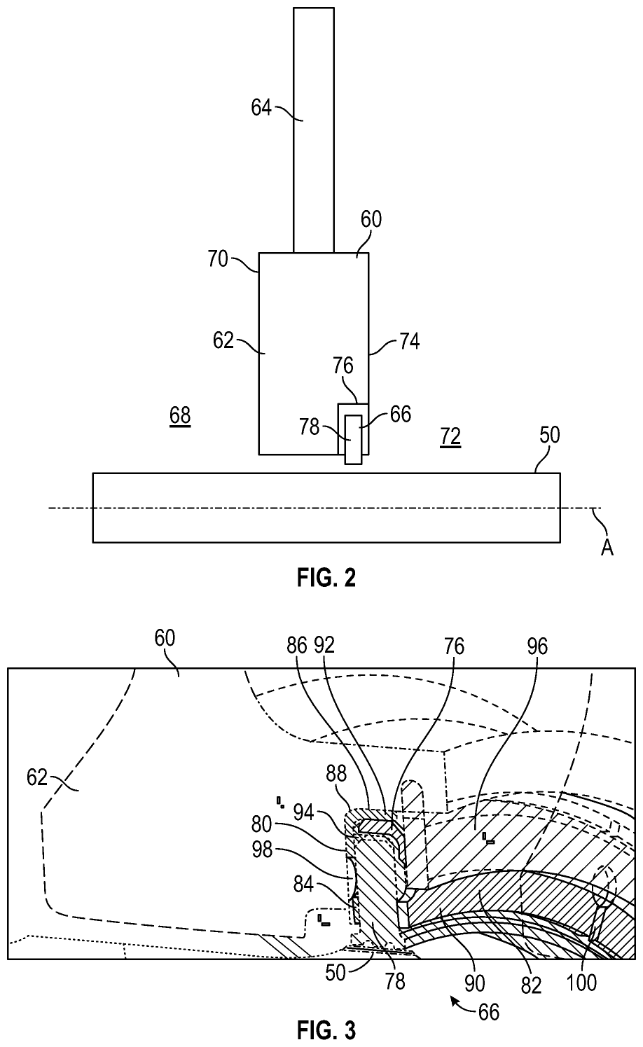

Referring now to FIG. 2, illustrated is an interface between a rotating shaft and a rotor of the engine 20. For example, the illustrated interface may be between outer shaft 50 and a rotor 60 of the high pressure compressor 54. It is to be appreciated, however, that the present disclosure may be similarly applied at other locations of the engine 20. The rotor 60 includes a rotor hub 62 and a plurality of rotor blades 64 extending radially outwardly from the rotor hub 62. A seal assembly 66 is located at the rotor hub 62 to seal between the rotor 60 and the shaft 50. This seal assembly 66 is configured to prevent leakage of airflow between a first cavity 68 located at a first axial side 70 of the rotor 60 and a second cavity 72 located at a second axial side 74 of the rotor 60.

An exemplary seal assembly 66 is illustrated in FIG. 3. The seal assembly 66 includes a seal carrier 76 and a seal body 78 disposed in the seal carrier 76, and configured to be the sealing element between the rotor 60 and the shaft 50. The seal body 78 is formed of a material to match the thermal growth and mechanical growth characteristics of the shaft 50, and in some embodiments the material of the seal body 78 is the same as the material of the shaft 50. The match in thermal growth and mechanical growth characteristics of the seal body 78 and the shaft 50 ensures the maintaining of close clearances between the seal body 78 and the shaft 50.

The seal carrier 76 includes two components, an axially forward seal carrier 80 and an axially aft seal carrier 82. The forward seal carrier 80 is L-shaped and includes a forward axial leg 84 and a forward radial leg 86. The forward seal carrier 80 is positioned in, for example, a notch 88 in the rotor hub 62. Alternatively, the forward seal carrier 80 may be positioned in other features of the rotor hub 62 such as a groove or other feature. Similarly, the aft seal carrier 82 includes an aft axial leg 90 and an aft radial leg 92, together defining an L-shaped aft seal carrier 82. When installed, in some embodiments the aft radial leg 92 at least partially overlaps the forward radial leg 86, and the forward seal carrier 80 and aft seal carrier 82 together define a U-shaped seal recess 94, wherein the seal body 78 is installed. In some embodiments, the aft seal carrier 82 has an interference fit to the forward seal carrier 80. To maintain the assembly, a snap ring 96 is installed to the rotor hub 62 aft of the aft seal carrier 82, and abutting the aft seal carrier 82. While in the embodiment illustrated in FIG. 2 the forward radial leg 86 is located radially outboard of the aft radial leg 92, in other embodiments the positioning may be reversed such that the aft radial leg 92 is positioned radially outboard of the forward radial leg 86.

In some embodiments, one or more of the forward seal carrier 80 and the aft seal carrier 82 are unitary full rings extending about the engine central longitudinal axis A. The forward seal carrier 80 includes a plurality of forward carrier cutouts 98 to allow for thermal and mechanical growth of the forward seal carrier 80 to match the thermal and mechanical growth of the rotor hub 62. Similarly, in some embodiments the aft seal carrier 82 includes a plurality of aft carrier cutouts 100 to allow for thermal and mechanical growth of the aft seal carrier 82 to match the thermal and mechanical growth of the rotor hub 62 and the forward seal carrier 60. The cutouts widths are set to not allow leakage through the seal, while also maintaining the integrity of the seal. The positions of the forward axial leg 84 and the aft axial leg 90 are determined such that there is a slight gap between the seal body 78 and the forward axial leg 84 and aft axial leg 90. This allows for sliding movement of the seal body 78 in the seal recess 94, and for the seal body 78 to center itself on the shaft 50 during operation of the engine 20. The number, size and shape of the cutouts 98 and 100 may be determined in order to provide the desired amount of relative sliding motion.

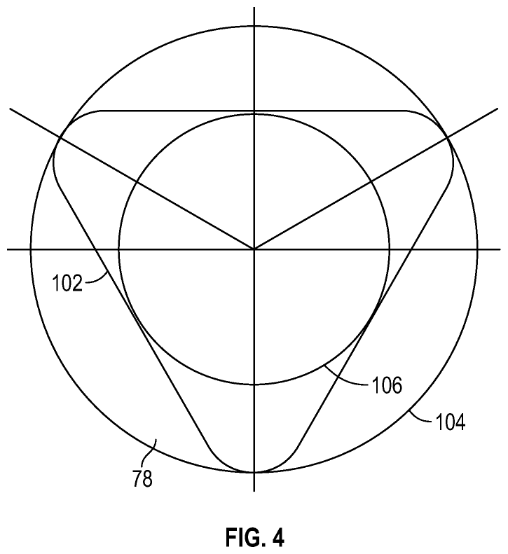

Referring now to FIG. 4, in some embodiments, a radially inner seal surface 102 is not a constant radius, but undulates between a maximum radius 104 and a minimum radius 106 defining, in some embodiments, a tri-lobe configuration which has three circumferential locations corresponding to the minimum radius 106. This configuration aids in preventing a full eccentric leakage pattern and resulting asymmetric thermal distortion off the components.

Referring again to FIG. 3, the seal assembly 66 is assembled by first installing the forward seal carrier 80 to the rotor hub 62, then the seal body 78 is installed to the forward seal carrier 80. Next, the aft seal carrier 82 is installed to the forward seal carrier 80 by an interference fit. Finally, the snap ring 96 is installed over the aft seal carrier 82. Alternatively, in another embodiment the forward seal carrier 80, the seal body 78 and the aft seal carrier 82 are assembled into a unitary seal assembly 66. This completed seal assembly 66 is then installed to the rotor hub 62, and the snap ring 96 is installed to retain the seal assembly 66 to the rotor hub 62.

The seal configurations disclosed herein reduce wear of the shaft and rotor components during operation of the engine 20 while maintaining an effective seal between the rotor 60 and the shaft 50.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A seal assembly for a gas turbine engine, comprising:
a seal carrier configured to be positioned at a first rotating component of the gas turbine engine, the seal carrier including:
an axially forward seal carrier; and
an axially aft seal carrier, the axially aft seal carrier disposed aft of the axially forward seal carrier relative to an engine central longitudinal axis, the axially forward seal carrier and the axially aft seal carrier defining a seal recess therebetween; and
a seal body disposed in the seal recess the seal body configured to slidably move in the seal recess and positioned to seal to a second rotating component of the gas turbine engine;
wherein the seal body is a full unitary ring extending around the engine central longitudinal axis and includes one or more undulations between a maximum radius and a minimum radius in the radial direction relative to the engine central longitudinal axis.

2. The seal assembly of claim 1, wherein an axial width of the seal recess is greater than an axial width of the seal body.

3. The seal assembly of claim 1, wherein:
the axially forward seal carrier includes:
a forward axial leg; and
a forward radial leg; and
the axially aft seal carrier includes:
an aft axial leg; and
an aft radial leg;
wherein one of the aft radial leg or the forward radial leg at least partially axially overlaps the other of the forward radial leg or the aft radial leg.

4. The seal assembly of claim 1, wherein a thermal growth and mechanical growth of the seal carrier matches a thermal growth and mechanical growth of the first rotating component during operation of the gas turbine engine.

5. The seal assembly of claim 1, wherein at least one of the axially forward seal carrier and the axially aft seal carrier includes a plurality of carrier slots to tune the thermal growth and mechanical growth performance of the seal carrier.

6. The seal assembly of claim 1, wherein a thermal growth and a mechanical growth of the seal body matches a thermal growth and a mechanical growth of the second rotating component during operation of the gas turbine engine.

7. (canceled)

8. The seal assembly of claim 1, wherein one or more of the axially forward seal carrier and the axially aft seal carrier and the seal body are full unitary rings extending around the engine central longitudinal axis.

9. A gas turbine engine comprising:
a shaft disposed at an engine central longitudinal axis, the shaft configured to rotate about the engine central longitudinal axis;
a rotor disposed radially outboard of the shaft and extending about the engine central longitudinal axis; and
a seal assembly including:
a seal carrier disposed at the rotor, the seal carrier including:
an axially forward seal carrier; and
an axially aft seal carrier, the axially aft seal carrier disposed aft of the axially forward seal carrier relative to the engine central longitudinal axis, the axially forward seal carrier and the axially aft seal carrier defining a seal recess therebetween; and
a seal body disposed in the seal recess the seal body configured to slidably move in the seal recess and seal to the shaft;
wherein the seal body is a full unitary ring extending around the engine central longitudinal axis and includes one or more undulations between a maximum radius and a minimum radius in the radial direction relative to the engine central longitudinal axis.

10. The gas turbine engine of claim 9, wherein an axial width of the seal recess is greater than an axial width of the seal body.

11. The gas turbine engine of claim 9, wherein:
the axially forward seal carrier includes:
a forward axial leg; and
a forward radial leg; and
the axially aft seal carrier includes:
an aft axial leg; and
an aft radial leg;
wherein the aft radial leg at least partially axially overlaps the forward radial leg.

12. The gas turbine engine of claim 9, wherein a thermal growth and a mechanical growth of the seal carrier matches a thermal growth and a mechanical growth of the rotor during operation of the gas turbine engine.

13. The gas turbine engine of claim 9, wherein at least one of the axially forward seal carrier and the axially aft seal carrier includes a plurality of carrier slots to tune the thermal growth and mechanical growth performance of the seal carrier.

14. The gas turbine engine of claim 9, wherein a thermal growth and a mechanical growth of the seal body matches a thermal growth and a mechanical growth of the shaft during operation of the gas turbine engine.

15. (canceled)

16. The gas turbine engine of claim 9, wherein one or more of the axially forward seal carrier and the axially aft seal carrier are full unitary rings extending around the engine central longitudinal axis.

17. A method of assembling a seal assembly of a gas turbine engine, comprising:
installing an axially forward seal carrier to a rotor of the gas turbine engine;
installing a seal body onto the axially forward seal carrier; and
installing an axially aft seal carrier to the axially forward seal carrier such that the seal body is disposed in a seal recess defined between the axially forward seal carrier and the axially aft seal carrier;
wherein the seal body is a full unitary ring extending around an engine central longitudinal axis and includes one or more undulations in the radial direction relative to the engine central longitudinal axis.

18. The method of claim 17, further comprising installing a snap ring to the rotor to secure the seal assembly to the rotor.

19. The method of claim 17, wherein the axially aft seal carrier is installed to the axially forward seal carrier via an interference fit.

20. The method of claim 17, wherein an axial width of the seal recess is greater than an axial width of the seal body in the seal recess.
